(19) United States
(12) Patent Application Publication
(10) Pub. No.: US 2019/0216072 A1
(43) Pub. Date: Jul. 18, 2019

(54) CASTING-STABILIZED FISHING FLOATS

(71) Applicant: UNITED PLASTIC MOLDERS, INC., Jackson, MS (US)

(72) Inventors: William Tucker HOGE, Jackson, MS (US); Don S. NORTON, Jackson, MS (US)

(21) Appl. No.: 16/329,370

(22) PCT Filed: Aug. 29, 2017
(86) PCT No.: PCT/US17/49043

§ 371 Date: Feb. 28, 2019

Related U.S. Application Data
(60) Provisional application No. 62/381,762, filed on Aug. 31, 2016.

(51) Int. Cl. A01K 93/02

(52) U.S. Cl. CPC A01K 93/02

(57) ABSTRACT

Fishing floats are provided with a buoyant float body, an elongate support spindle having proximal and distal ends, and a fletching member attached to the proximal end of the float body. The float body is connected to the support spindle to allow reciprocal rectilinear movements of the float body along the support spindle between the proximal and distal ends thereof. The support spindle is of a length such that the fletching member is positioned in spaced and abutted relationships relative to the float body in response to the reciprocal rectilinear movements of the float body between the proximal and distal ends of the support spindle. In such a manner, the float body may be stabilized during casting as well as providing a visual strike indication.

### CROSS-REFERENCE TO RELATED APPLICATION

This application is related to commonly owned U.S. Design patent application Ser. No. 29/576,059 entitled Design For: Fishing Float (Atty. Dkt. No. BHD-2310-28) filed concurrently herewith, the entire content of which is expressly incorporated hereinto by reference.

### FIELD

The embodiments disclosed herein relate generally to fishing line floats, more particularly fishing floats that are known in the art as “popping corks”.

### BACKGROUND

Floating devices which also serve to attract fish toward bait tackle suspended below the water by virtue of vibration (sound) frequencies emitted thereby and/or the ripple effects on the surface of the water when the float is retrieved by an angler are well known. These types of so-called “popping corks” are well known fishing line floats which serve to disturb or agitate the water surface when retrieved by the angler. See in this regard, U.S. Pat. No. 2,186,281 (the entire content of which is expressly incorporated hereinto by reference). The “popping cork” type of fishing floats also provide a visual indication when a fish has struck the submerged bait tackle due to the float being pulled physically under the water surface by the fish.

While fishing floats generally and “popping corks” more specifically are suitable for their intended purpose of attracting fish and serving as a visible strike indicator, certain improvements are still desired. For example, anglers will typically cast the float and the bait tackle attached to the distal end of the float by way of a leader line a sufficient distance across the water using a rod and reel assembly. This casting of the bait tackle will thereby allow the float and bait tackle attached to its distal end to be retrieved with the rod and reel assembly using various angling techniques (e.g., “walking the dog” action) intended to attract fish to the suspended bait tackle where the fish (hopefully) will strike the bait and be caught.

One problem associated with conventional floats is that, due to their light weight, they are not particularly stable when thrown along with the line during casting. This casting-instability may therefore sometimes cause the fishing line and/or leader line to become wrapped around the float which precludes the float from functioning as intended. It would therefore be desirable if fishing floats of the type colloquially known as “popping corks” could be provided with cast-stabilization features which would minimize (if not eliminate) such a problem during casting. It is towards providing such an improvement that the embodiments disclosed herein are directed.

### SUMMARY

According to certain embodiments, fishing floats may be provided with a buoyant float body, an elongate support spindle having proximal and distal ends, and a fletching member attached to the proximal end of the support spindle to allow relative reciprocal rectilinear movements to occur between the fletching member and the float body along the support spindle. The support spindle is of a length such that the fletching member is positioned in proximally spaced and abutted relationships relative to an end of the float body in response to the reciprocal relative rectilinear movements between the float body and the support spindle. In such a manner, the float body may be stabilized during casting as well as providing a visual strike indication.

The fletching member includes a plurality of radially extended rigid fletchings. According to certain embodiments, the fletching member includes a tubular hub that is coaxially sleeved around and immovably fixed to the proximal end of the support spindle. The rigid fletchings may thus radially extend outwardly from the hub and so as to be substantially equally circumferentially spaced apart from one another. That is, if three rigid fletchings or fins are provided, then each radially extends outwardly from the tubular hub and are circumferentially spaced-apart from one another by about 120°.

According to some embodiments, the buoyant float body may be in the form of a hollow generally conically shaped float body. The float body may thus include a convexly arcuate distal end and a substantially planar proximal end defining a substantially circular proximal edge region.

If the float body is hollow, then it is preferably sealingly closed at the proximal end thereof by a cap plug. The cap plug may be recessed below the substantially circular proximal edge region of the hollow float body so as to provide an advantageous “popping” vibration in the body of water as the lure is retrieved thereby serving as a fish attractant. Furthermore, the cap plug may have an exterior concave surface.

The cap plug may include a tubular central post extending distally of the cap plug and sleeved over the support spindle. The float body may therefore cooperatively include an interior socket which receives a distal end of the tubular central post, wherein the distal end of the tubular central post is sealingly connected to the interior socket. A plurality of interior beads freely moveable within an interior space of the hollow float body. Alternatively or additionally, a plurality of exterior beads coaxially attached to the support spindle so as to be freely moveable therealong. The rattling vibration caused by the interaction of the interior and exterior beads will therefore provide relatively high and low frequency vibrations to occur to thereby serve as a fish attractant.

Certain embodiments will include a support spindle having an eyelet at each of its proximal and distal ends. The eyelets will preferably include an elastomeric eyelet guard. In certain forms, the eyelet guard is a heat-shrunk tubular elastomeric member that covers a portion of the support spindle and a portion of the eyelet joining the support spindle.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a side elevational view showing the casting-stabilized fishing float in accordance with an embodiment of this invention which is depicted floating on the surface of a body of water during use;

FIG. 2 is a detailed proximal end perspective view of the fishing float shown in FIG. 1;

FIG. 3 is a side elevational view thereof;

FIGS. 4 and 5 are bottom and top plan views thereof, respectively;

FIGS. 6 and 7 are proximal and distal end elevational views thereof, respectively;

FIG. 8 is a distal end perspective view thereof;

FIG. 9 is a distal end perspective view thereof that is partly in sectioned to reveal the interior of the fishing float;

FIG. 10 is a cross-sectional elevational view of the fishing float as taken along lines 9-9 in FIG. 7; and

FIGS. 11A and 11B depict the fishing float when being cast and retrieved, respectively.

### DETAILED DESCRIPTION

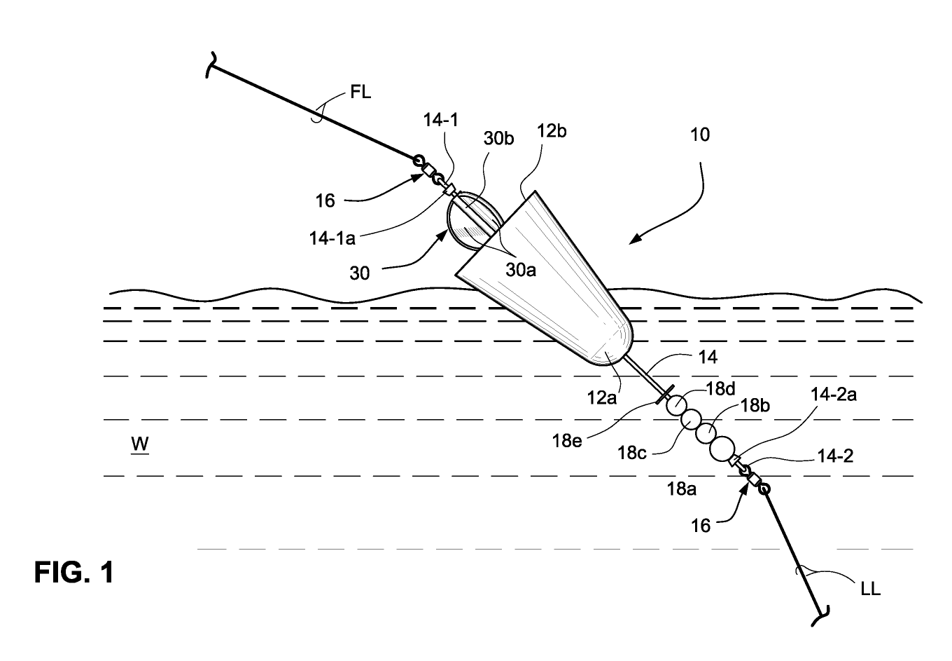

As shown in FIG. 1, the fishing float 10 is sufficiently bouant so as to float on the surface of a body of water W when in use. The fishing float 10 is generally comprised of a generally conically shaped buoyant hollow float body 12 having a convexly arcuate (e.g., substantially hemispherical) distal end 12a and a substantially planar proximal end 12b that defines a substantially circular proximal edge region. The float body 12 is connected to a center support spindle 14 extending coaxially through the body 12 so as to be moveable rotationally about and longitudinally along the axis of the rod 14.

A proximal end of the support spindle 14 includes a proximal eyelet assembly 14-1 while a distal end of the support spindle 14 includes a distal eyelet assembly 14-2. Each of the proximal and distal eyelet assemblies 14-1, 14-2, respectively, are preferably provided with conventional fishing swivel eyelets 16 for attachment to the terminal end of a fishing line FL and to a proximal end of a lead line LL. It will of course be understood that the fishing line FL extends to an angler's rod and reel assembly so that the fishing line may be retrieved and cast as desired and that the lead line LL extends to bait tackle which typically includes a hook carrying live or synthetic fish bait. The lead line LL may itself be weighted somewhat heavier than the fishing float 10 and/or may alternatively or additionally carry a weight near the hook sufficient to ensure that the bait tackle submerges below the surface of the body of water W but insufficient to submerge the float body 12.

The support spindle 14 may also include a series of exterior beads 18a-18d distally of the end 14b of the float body 12. At least the distalmost bead 18a is preferably immovably fixed to the spindle 14 whereas the more proximal beads 18b-18d are freely slideable along the spindle 14. The beads 18a-18d are formed of rigid materials that are selected to emit a desired sound. In this regard, the immovably fixed bead 18a may be formed of a metal (e.g., brass) whereas the moveable beads 18b-18d may be formed of a plastics material (e.g., nylon, polyolefin or the like). A metallic or plastic washer 18e may also be provided moveably on the spindle 14 between the bead 18d and the distal end 12a of the float body. Thus, movement of the beads 18b-18d and/or washer 18e will cause contact among adjacent ones and with the fixed bead 18a thereby providing a low frequency vibration in the body of water W for use as a fish attractant.

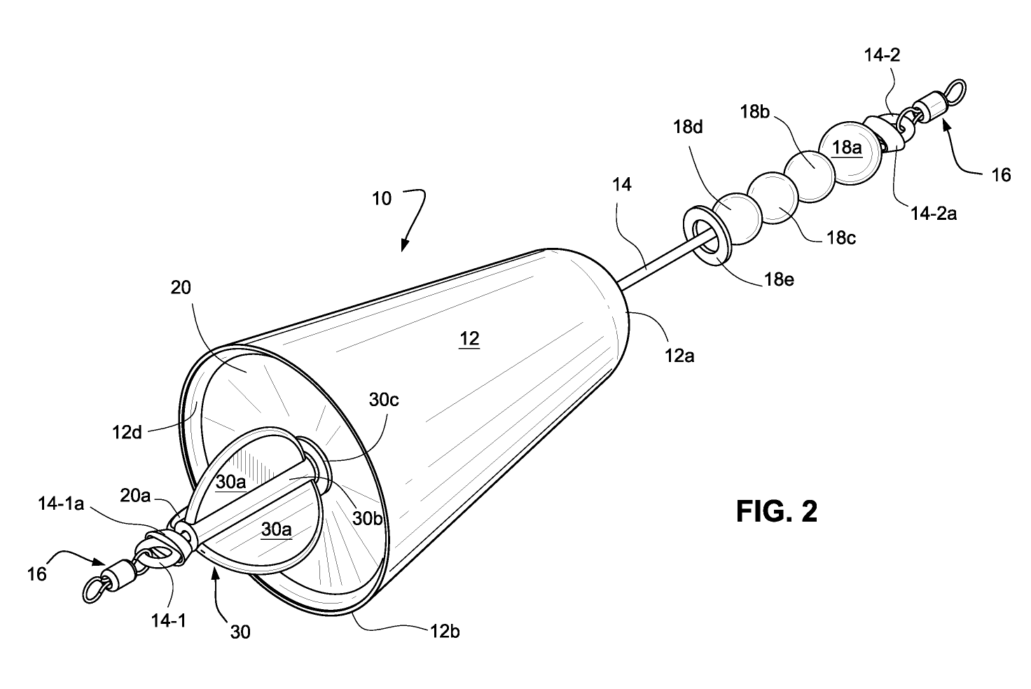

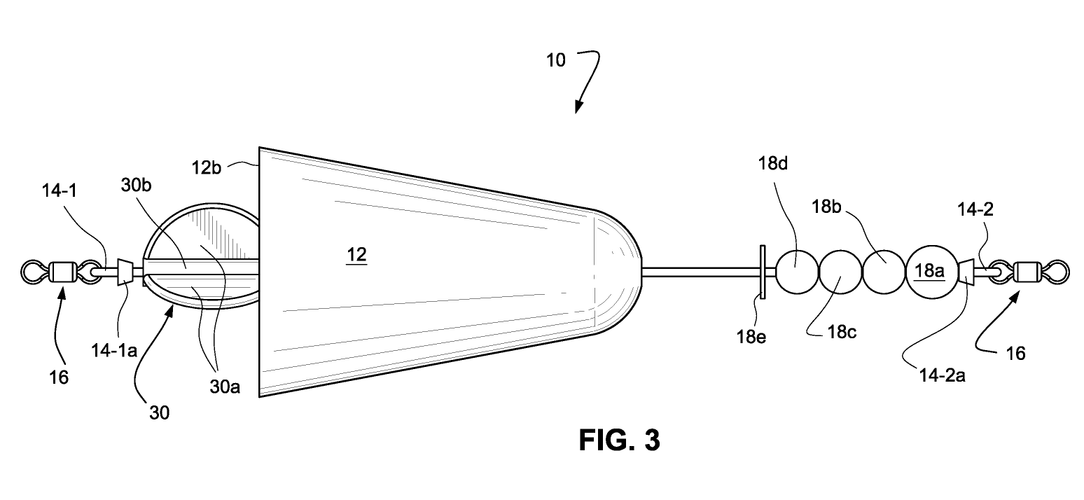

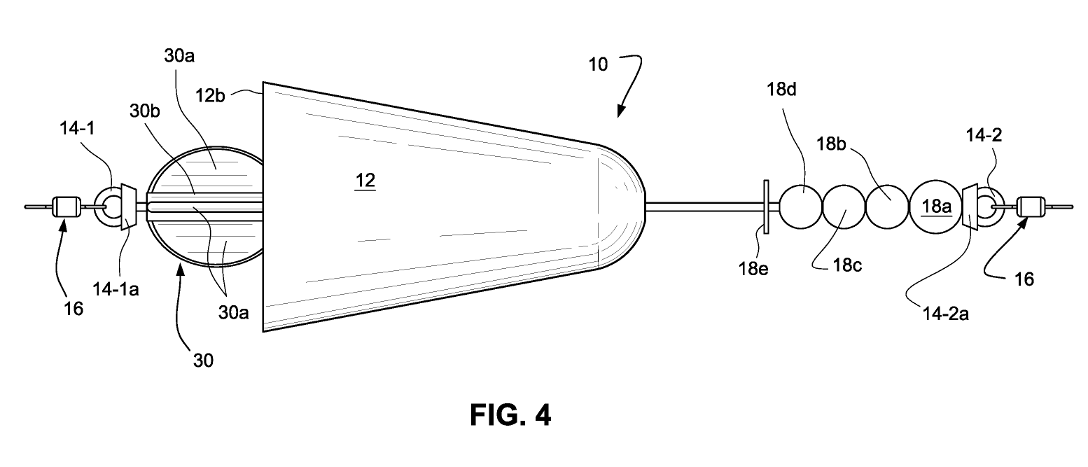

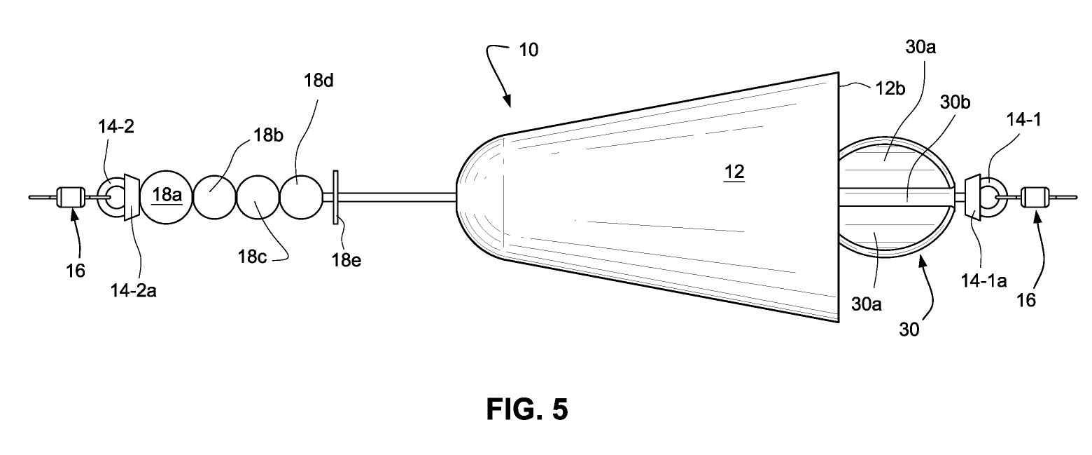

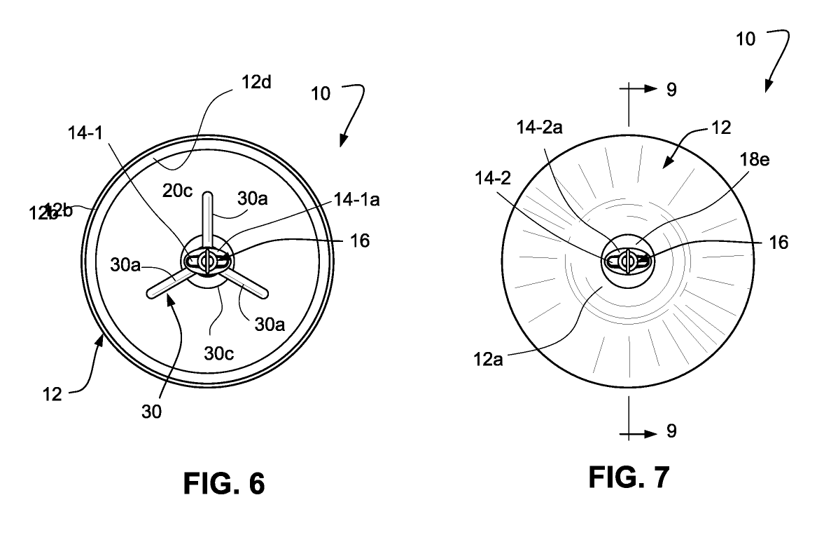

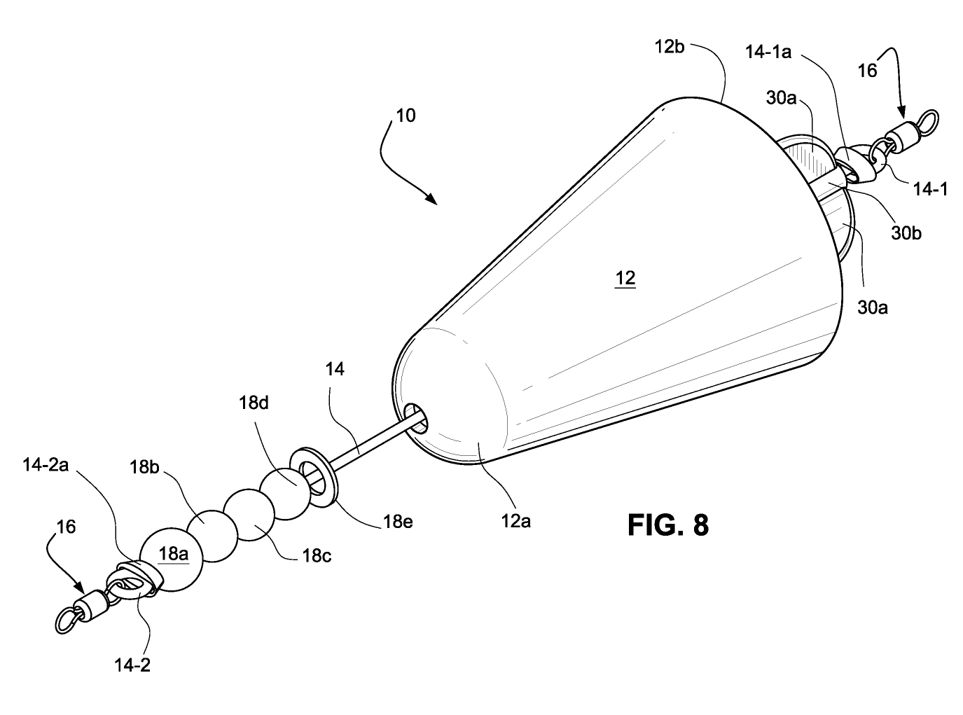

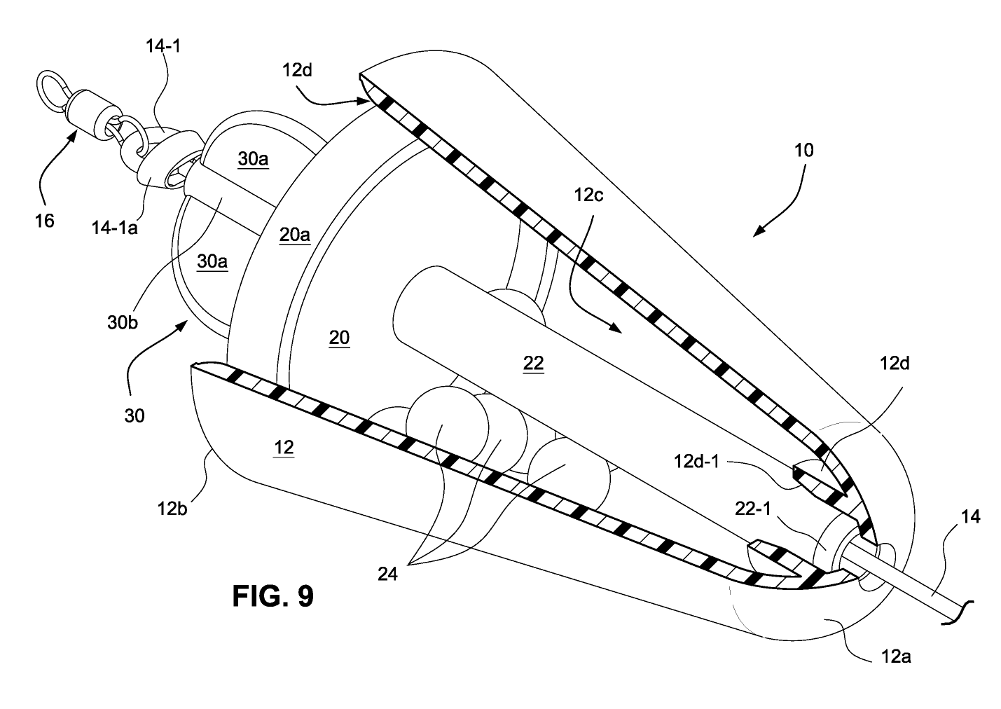

As is perhaps more clearly shown in the enlarged views of FIGS. 2-8, the eyelets 14-1 and 14-2 are partially covered with an eyelet guard 14-1a and 14-2a, respectively. Since the eyelets 14-1 and 14-2 are formed of a turned section at the respective ends of the spindle 14, the eyelet guards 14-1a, 14-2a serve to provide a collar around the eyelets 14-1 and 14-2, respectively, so as to prevent the fishing line FL and the lead line LL from inadvertently wrapping around and entering the eyelet to thereby preclude line entanglement.

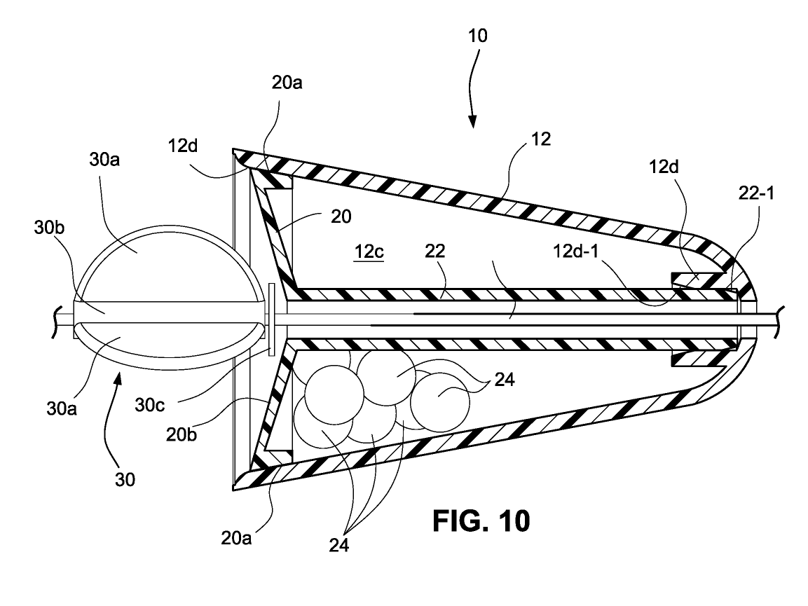

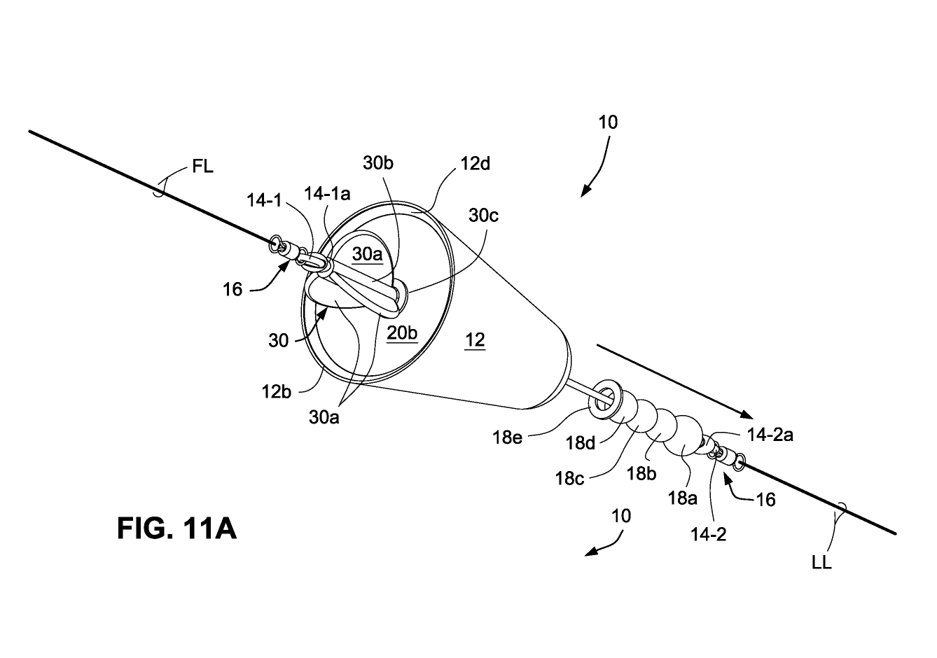

As shown in FIGS. 9 and 10, the proximal end 12b of the float body 12 is closed by a circular cap plug 20 which includes a tubular central post 22 extending distally therefrom. The circumferential edge 20a is conically beveled so as to mate with the interior surface of the float body 12 near the proximal end 14a thereof. The circumferential edge 20a may thus be adhesively joined to the float body 12 to thereby seal the interior space 12c thereof from the external environment. The distal end of the central post 22 is also received by and adhesively connected to an interior socket 12d at the distal end 12b of the float body 12 so as to likewise provide a water-tight seal thereat. The interior space 12c of the float body 12 is thereby sealed against water ingression. In order to assist assembly, the entrance surface 12d-1 and the external distal surface 22-1 are beveled.

As shown, the support spindle 14 extends through the tubular central post 22 so that the float body 12 may be freely moveable along and rotatable about the axis of the spindle 14. The interior space 12c may be provided with rigid interior beads (a representative few of which are identified by reference numeral 24) that will, like the exterior beads 18a-18d, provide a rattling sound for use as a fish attractant. Moreover, since the beads 24 are contained within the water-vacant space 12c of the float body 12, the rattling vibrations will be of a somewhat higher frequency as compared to the underwater rattling provided by means of the beads 18a-18d.

It will also be observed that the cap plug 20 has a concave external surface 20b which is seated below the substantially circular edge of the proximal end 12b of the float body 12 thereby establishing a recessed lip 12d. The concave external surface 20b and the recessed lip 12d thereby contribute to a “popping” sound and vibration as the float 10 is pulled along the surface of the body of water W when being retrieved by the angler. Such “popping” vibration will also serve as a fish attractant.

Important to the embodiments disclosed herein, the support spindle 14 includes a fletching member 30 preferably formed of a molded rigid plastics material (e.g., nylon, polyolefin or the like). The fletching member 30 includes a plurality of substantially equally circumferentially spaced-apart rigid fletchings or fins 30a fixed to and radially extending from a tubular hub 30b. In the embodiment shown, the fletching member 30 includes three rigid fletchings 30a that are circumferentially spaced apart from one another by about 120°. The hub 30b is sleeved over and immovably fixed to the support spindle 14 near the proximal eyelet 14-1 and its eyelet guard 14-1a. A washer 30c may be provided between the distal end of the hub 30b and the concave surface 20b to ensure that the latter is freely moveable relative to the former.

In the embodiment depicted in the accompanying drawings, the eyelet guards 14-1a, 14-2a are in the form of tubular sections of an elastomeric plastic tube that is heat shrunk around a portion of the eyelets 14-1 and 14-2, respectively. The eyelet guard 14-1a could however be formed integrally with the proximal end of fletching member 30 so as to be press-fit onto a portion of the eyelet 14-1 and thereby serve to positionally fix the fletching member 30 relative to the spindle 14 as well as guard against fishing line becoming snagged in the eyelet 14-1 as previously described.

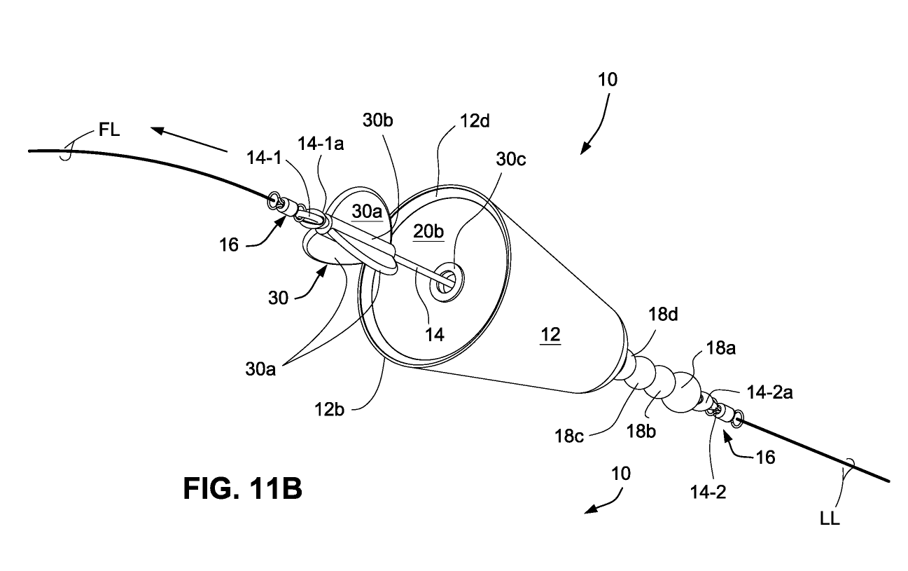

As can be seen, e.g., by FIGS. 11A and 11B, the support spindle 14 is of sufficient length so as to allow the float body 12 to be reciprocally moveable therealong between the proximal and distal eyelets 14-a and 14-2 thereof, respectively. This movement of the float body 12 will in turn cause the positional relationship between the fletching member 30 and the float body 12 to change depending, e.g., whether the float 10 is being cast with the weighted bait tackle (not shown) as depicted in FIG. 11A or whether the float 10 is being retrieved by the angler's reel (not shown) as depicted in FIG. 11B.

Thus, the fletching member 30 will be responsively caused to be positioned proximally against or spaced from the concave surface 20b of the cap plug 20. When being cast, therefore, the fletching member 30 may be positioned closely against, e.g., in abutting relationship to, the concave surface 20b of the cap plug 20 as shown by FIG. 11A such that the individual rigid fletchings or fins 30a serve to stabilize the float 10 during flight. When being retrieved, however, the fletching member 30 will be positioned in spaced relationship to the concave surface 20b of the cap plug 20 as shown by FIG. 11B so that a fish strike on the bait tackle attached to the lead line LL will initially cause the fletching member 30 to be physically moved toward the concave surface 20b of the cap plug 20 thereby providing visual strike indication. Strike indication may also be enhanced by providing the fletching member 30 with a visibly bright color, e.g., bright pink, orange, yellow or the like, in contrast to a relatively dull colored (e.g., black or grey) float body 12. Such a color contrast will therefore allow the angler to more easily visibly detect strike indications by virtue of the movement of the fletching member 30 relative to the proximal end of the float body 12.

As is now apparent, the fishing float 10 which embodies the features of the invention as described herein provide substantial improvements over the floats currently known to those in the art. However, while the invention has been described in connection with what is presently considered to be the most practical and preferred embodiments thereof, it is to be understood that the invention is not to be limited to the disclosed embodiment, but on the contrary, is intended to cover various modifications and equivalent arrangements included within the spirit and scope thereof.

What is claimed is:

1. A fishing float comprising:
a buoyant float body;
an elongate support spindle having proximal and distal ends extending through the float body to allow for relative reciprocal movement between the float body and the support spindle; and
a fletching member attached to the proximal end of the support spindle to allow the fletching member to move with the support spindle relative to the float body, wherein
the support spindle is of a length such that the fletching member is positioned in proximally spaced and abutted relationships relative to an end of the float body in response to the relative reciprocal rectilinear movements between the float body and the support spindle.

2. The fishing float as in claim 1, wherein the fletching member includes a plurality of radially extended rigid fletchings.

3. The fishing float as in claim 2, wherein the fletching member includes a tubular hub that is coaxially sleeved around and immovably fixed to the proximal end of the support spindle.

4. The fishing float as in claim 3, wherein the rigid fletchings radially extend outwardly from the hub and are substantially equally circumferentially spaced apart from one another.

5. The fishing float as in claim 1, wherein the float body is a hollow generally conically shaped float body.

6. The fishing float as in claim 5, wherein the float body has a convexly arcuate distal end and a substantially planar proximal end defining a substantially circular proximal edge region.

7. The fishing float as in claim 6, wherein the float body further comprises a cap plug sealingly closing the proximal end of the hollow float body.

8. The fishing float as in claim 7, wherein the cap plug is recessed below the substantially circular proximal edge region of the hollow float body.

9. The fishing float as in claim 7, wherein the cap plug includes an exterior concave surface.

10. The fishing float as in claim 7, wherein the cap plug includes a tubular central post extending distally of the cap plug and sleeved over the support spindle.

11. The fishing float as in claim 10, wherein the float body includes an interior socket which receives a distal end of the tubular central post, wherein the distal end of the tubular central post is sealingly connected to the interior socket.

12. The fishing float as in claim 5, further comprising a plurality of interior beads freely moveable within an interior space of the hollow float body.

13. The fishing float as in claim 1, further comprising a plurality of exterior beads coaxially attached to the support spindle so as to be freely moveable therealong.

14. The fishing float as in claim 1, wherein each of the proximal and distal ends of the support spindle includes an eyelet.

15. The fishing float as in claim 14, wherein the eyelet includes an elastomeric eyelet guard.

16. The fishing float as in claim 15, wherein the eyelet guard is a heat-shrunk tubular elastomeric member that covers a portion of the support spindle and a portion of the eyelet joining the support spindle.

17. The fishing float as in claim 16, wherein the fletching member includes a plurality of radially extended rigid fletchings.

18. The fishing float as in claim 17, wherein the fletching member includes a tubular hub that is coaxially sleeved around and immovably fixed to the proximal end of the support spindle.

19. The fishing float as in claim 18, wherein the rigid fletchings radially extend outwardly from the hub and are substantially equally circumferentially spaced apart from one another.

20. The fishing float as in claim 16, wherein the float body is a hollow generally conically shaped float body.

21. The fishing float as in claim 20, wherein the float body has a convexly arcuate distal end and a substantially planar proximal end defining a substantially circular proximal edge region.

22. The fishing float as in claim 21, wherein the float body further comprises a cap plug sealingly closing the proximal end of the hollow float body.

23. The fishing float as in claim 22, wherein the cap plug is recessed below the substantially circular proximal edge region of the hollow float body.

24. The fishing float as in claim 22, wherein the cap plug includes an exterior concave surface.

25. The fishing float as in claim 22, wherein the cap plug includes a tubular central post extending distally of the cap plug and sleeved over the support spindle.

26. The fishing float as in claim 25, wherein the float body includes an interior socket which receives a distal end of the tubular central post, wherein the distal end of the tubular central post is sealingly connected to the interior socket.

27. The fishing float as in claim 20, further comprising a plurality of interior beads freely moveable within an interior space of the hollow float body.

28. The fishing float as in claim 16, further comprising a plurality of exterior beads coaxially attached to the support spindle so as to be freely moveable therealong.
